(19) United States
(12) Patent Application Publication
(10) Pub. No.: US 2005/0208945 A1
(43) Pub. Date: Sep. 22, 2005

(54) System and method for performing network re-entry upon handover of mobile subscriber station in a broadband wireless access communication system

(75) Inventors: Seung-Eun Hong, Suwon-si (KR); Bong-Gee Song, Seongnam-si (KR); Kwang-Seop Eom, Seongnam-si (KR); Min-Hee Cho, Suwon-si (KR); Hyeong-Jong Ju, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/071,740

(22) Filed: Mar. 3, 2005

(30) Foreign Application Priority Data
Mar. 3, 2004 (KR) 10-2004-0014335

(51) Int. Cl. H04Q 7/20

(52) U.S. Cl. 455/436

(57) ABSTRACT

A system for performing network re-entry upon handover of a mobile subscriber station (MSS) to a target base station (BS). Upon detecting handover of the MSS, the target BS detects network re-entry information necessary for network re-entry of the MSS from the serving BS, and transmits, to the MSS, the detected network re-entry information, information on an acknowledge (ACK) channel through which the MSS will respond that it has received the network re-entry information upon receipt of the network re-entry information, and ACK request information requesting the MSS to respond whether it has received the network re-entry information. The MSS receives the ACK channel information, and thereafter receives, from the target BS, the network re-entry information and the ACK request information, and a response transmits to the target BS which indicates that it has received the network re-entry information, through the ACK channel in response to the ACK request information.

### PRIORITY

This application claims priority under 35 U.S.C. § 119 to an application entitled “System and Method for Performing Network Re-entry upon Handover of Mobile Subscriber Station in a Broadband Wireless Access Communication System” filed in the Korean Intellectual Property Office on Mar. 3, 2004 and assigned Serial No. 2004-14335, the contents of which are incorporated herein by reference.

### BACKGROUND OF THE INVENTION

1. Field of the Invention

The present invention relates generally to a Broadband Wireless Access (BWA) mobile communication system, and in particular, to a system and method for performing network re-entry upon handover of a mobile subscriber station.

2. Description of the Related Art

Research on a 4^{th} generation (4G) communication system (which is the next generation communication system) is being conducted to provide users with services having various Qualities-of-Service (QoSs) at a transfer rate of 100 Mbps or higher. Particularly, in the current 4G communication system, active research is being carried out on technology for supporting high-speed services which can provide for mobility and guarantee QoS in a BWA communication system such as a wireless Local Area Network (LAN) system and a wireless Metropolitan Area Network (MAN) system, and the typical communication systems include an Institute of Electrical and Electronics Engineers (IEEE) 802.16a communication system and an IEEE 802.16e communication system.

The IEEE 802.16a communication system and the IEEE 802.16e communication system refer to communication systems using an Orthogonal Frequency Division Multiplexing (OFDM) scheme and/or an Orthogonal Frequency Division Multiple Access (OFDMA) scheme in order to support a broadband transmission network to a physical channel of the wireless MAN system. The IEEE 802.16a communication system refers to a system that considers only a state in which a subscriber station (SS) is located in a fixed position (i.e., mobility of an SS is never taken into consideration), and a unicell structure. Unlike the IEEE 802.16a communication system, the IEEE 802.16e communication system refers to a system that considers mobility of an SS in the IEEE 802.16a communication system, and in the IEEE 802.16e communication system, the SS is called a “mobile subscriber station (MSS).”

With reference to FIG. 1, a description will now be made of a configuration of the IEEE 802.16e communication system.

FIG. 1 is a diagram schematically illustrating a configuration of a general IEEE 802.16e communication system. The IEEE 802.16e communication system has a multicell structure, i.e., has a cell 100 and a cell 150, and is comprised of a base station (BS) 110 managing the cell 100, a BS 140 managing the cell 150, and a plurality of MSSs 111, 113, 130, 151 and 153. Signal exchange between the base stations 110 and 140 and the MSSs 111, 113, 130, 151 and 153 is achieved using the OFDM/OFDMA scheme. However, among the MSSs 111, 113, 130, 151 and 153, the MSS 130 is located in a boundary region of the cell 150, i.e., a handover region. If the MSS 130 physically moves towards the cell 150 managed by the BS 140 while exchanging signals with the BS 110, its serving BS is changed from the BS 110 to the BS 140.

The configuration of the general IEEE 802.16e communication system has been described with reference to FIG. 1. Next, with reference to FIG. 2, a description will be made of a network re-entry operation with a target BS upon occurrence of handover in the IEEE 802.16e communication system.

FIG. 2 is a flow diagram illustrating a network re-entry process with a target BS upon occurrence of handover in a general IEEE 802.16e communication system. Referring to FIG. 2, once an MSS 200 is handed over to a target BS 250, it performs an initial ranging operation with the target BS 250. The MSS 200 acquires downlink (DL) and uplink (UL) synchronizations through the initial ranging operation, and then performs Bandwidth Request (BW-REQ) random access with the target BS 250 (Step 211). Here, the BW-REQ random access refers to a random access in which the MSS 200 requests allocation of a bandwidth for transmitting a BW-REQ message in order to perform actual communication with the target BS 250, and is performed on a contention basis. If the BW-REQ random access is successful, the target BS 250 transmits a uplink-map (UL-MAP) message including a Code Division Multiple Access Allocation Information Element (CDMA Allocation IE) allocated to the MSS 200 according to the BW-REQ random access of the MSS 200 (Step 213). Here, the CDMA Allocation IE includes information on an uplink bandwidth through which the MSS 200 will transmit the BW-REQ message.

The MSS 200 receiving the UL-MAP message from the target BS 250 detects the CDMA Allocation IE included in the UL-MAP message, and transmits a BW-REQ message to the target BS 250 using an uplink resource (i.e., an uplink bandwidth), included in the CDMA Allocation IE (Step 215). The target BS 250 receiving the BW-REQ message from the MSS 200 allocates an uplink bandwidth for data transmission of the MSS 200. Thereafter, the target BS 250 transmits a UL-MAP message including information on an uplink bandwidth allocated for data transmission of the MSS 200 (Step 217).

The MSS 200 receiving the UL-MAP message from the target BS 250 recognizes the uplink bandwidth allocated for data transmission, and transmits a Subscriber Station's Basic Capability Negotiation Request (SBC-REQ) message to the target BS 250 through the uplink bandwidth (Step 219). Here, the SBC-REQ message refers to a Medium Access Control (MAC) message that the MSS 200 transmits for negotiation on a basic capability with the target BS 250, and includes information on a modulation scheme and a coding scheme that can be supported by the MSS 200. After receiving the SBC-REQ message from the MSS 200 and detecting a modulation scheme and a coding scheme supportable by the MSS 200, included in the received SBC-REQ message, the target BS 250 transmits a Subscriber Station's Basic Capability Negotiation Response (SBC-RSP) message in response to the SBC-REQ message (Step 221).

Upon receiving the SBC-RSP message, in order to transmit a Privacy Key Management Request (PKM-REQ) message to the target BS 250 the MSS 200 repeats the foregoing BW-REQ random access operation, a BW-REQ message transmission operation and a UL-MAP message reception operation corresponding to the BW-REQ message transmission operation. That is, the MSS 200 should repeat steps 223 to 229. However, because steps 223 to 229 are equivalent to the operations performed in steps 211 to 217, a detailed description thereof will be omitted.

Thereafter, the MSS 200 transmits a PKM-REQ message to the target BS 250 (Step 231). Here, the PKM-REQ message refers to a MAC message for authentication on the MSS 200, and includes certificate information of the MSS 200. The target BS 250 receiving the PKM-REQ message performs authentication with an authentication server (AS, not shown) using the certificate information of the MSS 200 included in the PKM-REQ message. If as a result of the authentication the MSS 200 is an authenticated MSS, the target BS 250 transmits a Privacy Key Management Response (PKM-RSP) message to the MSS 200 in response to the PKM-REQ message (Step 233). Here, the PKM-RSP message includes an authentication key (AK) and a traffic encryption key (TEK), both allocated to the MSS 200.

Upon receiving the PKM-RSP message, in order to transmit a Registration Request (REG-REQ) message to the target BS 250 the MSS 200 repeats the foregoing BW-REQ random access operation, a BW-REQ message transmission operation and a UL-MAP message reception operation corresponding to the BW-REQ message transmission operation. That is, the MSS 200 should repeat steps 235 to 241. However, because steps 235 to 241 are equivalent to the operations in steps 211 to 217, a detailed description thereof will be omitted.

Thereafter, the MSS 200 transmits a REG-REQ message to the target BS 250 (Step 243). Here, the REG-REQ message includes MSS registration information of the MSS 200. The target BS 250 receiving the REG-REQ message registers the MSS 200 in the target BS 250 by detecting the MSS registration information included in the REG-REQ message, and transmits a Registration Response (REG-RSP) message to the MSS 200 in response to the REG-REQ message (Step 245). Here, the REG-RSP message includes registration information of the registered MSS.

The network re-entry operation with the target BS upon occurrence of handover in the general IEEE 802.16e communication system has been described with reference to FIG. 2. Next, with reference to FIG. 3, a description will be made of the BW-REQ random access process in FIG. 2.

FIG. 3 is a flow diagram illustrating the BW-REQ random access operation in FIG. 2. Before a description of FIG. 3 is given, it should be noted that although several BW-REQ random access processes are illustrated in FIG. 2, only the BW-REQ random access process in step 211 will be described for the sake of simplicity.

Referring to FIG. 3, the MSS 200 transmits a ranging code for transmitting the BW-REQ message to the target BS 250 (Step 311; Ranging Code for BW-REQ). Here, if the transmitted ranging code suffers collision (i.e., if other MSSs use the same ranging code as the ranging code transmitted by the MSS 200), the target BS 250 cannot recognize the ranging code transmission by the MSS 200. In this case, because there is no response from the target BS 250 even though the MSS 200 transmitted the ranging code, the MSS 200 waits for a predetermined backoff value, determining that the ranging code transmission is failed (Step 313). Here, the backoff value is determined according to a Truncated Binary Exponential Backoff (TBEB) algorithm.

Thereafter, the MSS 200 retransmits the ranging code for transmitting the BW-REQ message to the target BS 250 (Step 315). Similarly, if the ranging code also suffers collision, the MSS 200 re-waits for a backoff value (Step 317). After waiting for the backoff value, the MSS 200 retransmits the ranging code for transmitting the BW-REQ message to the target BS 250 (Step 319).

If the target BS 250 recognizes the transmitted ranging code in step 319, it transmits a UL-MAP message including a CDMA Allocation IE allocated to the MSS 200 according to the BW-REQ random access operation of the MSS 200 as described with reference to FIG. 2 (Step 213). Of course, if the ranging code transmitted in step 311 of FIG. 3 does not suffer collision, the operations of steps 313 to 319 are unnecessary.

As described with reference to FIG. 3, when the MSS performs the network re-entry operation with the target BS, it should transmit a plurality of messages, and in order to do so, the MSS should perform BW-REQ random access operation.

However, the BW-REQ random access operation may suffer an access delay, as it is performed on a contention basis. This access delay causes a delay in the network re-entry operation upon handover. In addition, the delay in the network re-entry operation results in a service delay, causing deterioration in QoS.

### SUMMARY OF THE INVENTION

It is, therefore, an object of the present invention to provide a system and method for performing network re-entry upon handover of an MSS in a BWA communication system.

It is another object of the present invention to provide a system and method for controlling an operation state in which network re-entry is performed with a minimum delay, in a BWA communication system.

It is further another object of the present invention to provide a MAC message transmission/reception system and method for performing reliable network re-entry in a BWA communication system.

According to a first aspect of the present invention, there is provided a method for performing network re-entry with a mobile subscriber station (MSS) by a target base station (BS) when the MSS is handed over to the target BS among a plurality of neighbor BSs, in a Broadband Wireless Access (BWA) communication system having the MSS, a serving BS providing a service to the MSS, and the plurality of neighbor BSs being different from the serving BS. In the method, the target BS includes the steps of upon detecting handover of the MSS, detecting network re-entry information necessary for network re-entry of the MSS from the serving BS, and transmitting the detected network re-entry information to the MSS.

According to a second aspect of the present invention, there is provided a method for performing network re-entry with a mobile subscriber station (MSS) by a target base station (BS) when the MSS is handed over to the target BS among a plurality of neighbor BSs, in a Broadband Wireless Access (BWA) communication system having the MSS, a serving BS providing a service to the MSS, and the plurality of neighbor BSs being different from the serving BS. In the method, the target BS includes the steps of allocating an acknowledge (ACK) time slot, and transmitting an uplink MAP (UL-MAP) message including information on the allocated ACK time slot to the MSS; after transmitting the UL-MAP message, generating a medium access control (MAC) message including a management message ACK allocation subheader (MMAASH) and transmitting the MAC message to the MSS; after transmitting the MAC message, determining whether a management message-acknowledge (MM-ACK) message is received from the MSS at an ACK time slot allocated to the MMAASH; if it is determined that an MM-ACK message is not received from the MSS at an ACK time slot allocated to the MMAASH, allocating an ACK time slot, and retransmitting a UL-MAP message including information on the allocated ACK time slot; and re-generating a MAC message including an MMAASH, and retransmitting the re-generated MAC message.

According to a third aspect of the present invention, there is provided a method for performing network re-entry with a mobile subscriber station (MSS) by a target base station (BS) when the MSS is handed over to the target BS among a plurality of neighbor BSs, in a Broadband Wireless Access (BWA) communication system having the MSS, a serving BS providing a service to the MSS, and the plurality of neighbor BSs being different from the serving BS, and having a frame including a downlink subframe including a plurality of downlink time slots and an uplink subframe including a plurality of uplink time slots. In the method, the target BS includes the steps of upon detecting handover of the MSS, detecting network re-entry information necessary for network re-entry of the MSS from the serving BS; after detecting the network re-entry information, transmitting acknowledge (ACK) channel information based on which the target BS will respond that it has received the network re-entry information, if the MSS receives the network re-entry information; and after transmitting the ACK channel information, transmitting, to the MSS, the detected network re-entry information, and ACK request information requesting the MSS to respond whether it has received the network re-entry information.

According to a fourth aspect of the present invention, there is provided a method for performing network re-entry with a target base station (BS) by a mobile subscriber station (MSS) when the MSS is handed over to the target BS among a plurality of neighbor BSs, in a Broadband Wireless Access (BWA) communication system having the MSS, a serving BS providing a service to the MSS, and the plurality of neighbor BSs being different from the serving BS. In the method, the MSS includes the steps of up receiving network re-entry information from the target BS during its handover to the target BS, receiving information on an acknowledge (ACK) channel through which the MSS will respond that it has received the network re-entry information; after receiving the ACK channel information, receiving the network re-entry information from the target BS; and after receiving the network re-entry information, responding to the target BS that it has received the network re-entry information, through the ACK channel.

According to a fifth aspect of the present invention, there is provided a method for performing network re-entry with a target base station (BS) by a mobile subscriber station (MSS) when the MSS is handed over to the target BS among a plurality of neighbor BSs, in a Broadband Wireless Access (BWA) communication system having the MSS, a serving BS providing a service to the MSS, and the plurality of neighbor BSs being different from the serving BS, and having a frame including a downlink subframe including a plurality of downlink time slots and an uplink subframe including a plurality of uplink time slots. In the method, the MSS includes the steps of up receiving network re-entry information from the target BS during its handover to the target BS, receiving information on an acknowledge (ACK) channel through which the MSS will respond that it has received the network re-entry information; after receiving the ACK channel information, receiving, from the target BS, the network re-entry information, and ACK request information requesting the MSS to respond that it has received the network re-entry information upon receipt of the network re-entry information; and after receiving the network re-entry information and the ACK request information, responding to the target BS that it has received the network re-entry information, through the ACK channel in response to the ACK request information.

According to a sixth aspect of the present invention, there is provided a method for performing network re-entry by a mobile subscriber station (MSS) when the MSS is handed over to a particular target base station (BS) among a plurality of neighbor BSs, in a Broadband Wireless Access (BWA) communication system having the MSS, a serving BS providing a service to the MSS, and the plurality of neighbor BSs being different from the serving BS. In the method, the MSS includes the steps of upon its handover from the serving BS to the target BS, acquiring downlink and uplink synchronizations through an initial ranging operation with the target BS; after acquiring the synchronizations, receiving messages including information for network re-entry from the target BS; and performing network re-entry to the target BS on a contention-free basis according to the messages received from the target BS.

According to a seventh aspect of the present invention, there is provided a method for performing network re-entry by a mobile subscriber station (MSS) when the MSS is handed over to a particular target base station (BS) among a plurality of neighbor BSs, in a Broadband Wireless Access (BWA) communication system having the MSS, a serving BS providing a service to the MSS, and the plurality of neighbor BSs being different from the serving BS. In the method, the MSS includes the steps of receiving a downlink-MAP (DL-MAP) message and an uplink-MAP (UL-MAP) message from the target BS, and analyzing the received DL-MAP message and UL-MAP message; receiving only a medium access control (MAC) message targeting the MSS through the message analysis result, preprocessing the received MAC message, and detecting a MAC header from the preprocessed MAC message; determining a value of the least significant bit (LSB) of the MAC header through the detection of the MAC header; if the LSB has a value of 1, recognizing that a management message acknowledge (ACK) allocation subheader (MMAASH) is included in the MAC message, and detecting and analyzing the MMAASH; and after detecting and analyzing the MMAASH, transmitting a management message-acknowledge (MM-ACK) message at an ACK time slot designated by the MMAASH.

According to an eighth aspect of the present invention, there is provided a method for performing network re-entry between a mobile subscriber station (MSS) and a particular target base station (BS) among a plurality of neighbor BSs within the shortest time when the MSS is handed over to the target BS, in a Broadband Wireless Access (BWA) communication system including the MSS, a serving BS providing a service to the MSS, and the plurality of neighbor BSs being different from the serving BS. In the method, upon its handover from the serving BS to the target BS, the MSS acquires downlink and uplink synchronizations through an initial ranging operation with the target BS. Upon handover of the MSS, the target BS transmits messages including information for network re-entry to the MSS regardless of reception of a request message from the MSS.

According to a ninth aspect of the present invention, there is provided a system for performing network re-entry when a mobile subscriber station (MSS) is handed over to a particular target base station (BS) among a plurality of neighbor BSs, in a Broadband Wireless Access (BWA) communication system having the MSS, a serving BS providing a service to the MSS, and the plurality of neighbor BSs being different from the serving BS. The system includes the target BS for, upon detecting handover of the MSS, detecting network re-entry information necessary for network re-entry of the MSS from the serving BS, and transmitting the detected network re-entry information to the MSS; and the MSS for receiving the network re-entry information.

According to a tenth aspect of the present invention, there is provided a system for performing network re-entry when a mobile subscriber station (MSS) is handed over to a particular target base station (BS) among a plurality of neighbor BSs, in a Broadband Wireless Access (BWA) communication system having the MSS, a serving BS providing a service to the MSS, and the plurality of neighbor BSs being different from the serving BS. The system includes the target BS for, upon detecting handover of the MSS, detecting network re-entry information necessary for network re-entry of the MSS from the serving BS, and transmitting, to the MSS, the detected network re-entry information, and information on an acknowledge (ACK) channel through which the MSS will respond that it has received the network re-entry information upon receipt of the network re-entry information; and the MSS for receiving the ACK channel information, thereafter, receiving the network re-entry information from the target BS, and responding to the target BS that it has received the network re-entry information, through the ACK channel.

According to a eleventh aspect of the present invention, there is provided a system for performing network re-entry when a mobile subscriber station (MSS) is handed over to a particular target base station (BS) among a plurality of neighbor BSs, in a Broadband Wireless Access (BWA) communication system including the MSS, a serving BS providing a service to the MSS, and the plurality of neighbor BSs being different from the serving BS, and including a frame including a downlink subframe comprised of a plurality of downlink time slots and an uplink subframe comprised of a plurality of uplink time slots. The system includes the target BS for, upon detecting handover of the MSS, detecting network re-entry information necessary for network re-entry of the MSS from the serving BS, and transmitting, to the MSS, the detected network re-entry information, information on an acknowledge (ACK) channel through which the MSS will respond that it has received the network re-entry information upon receipt of the network re-entry information, and ACK request information requesting the MSS to respond whether it has received the network re-entry information; and the MSS for receiving the ACK channel information, thereafter receiving, from the target BS, the network re-entry information and the ACK request information, and responding to the target BS that it has received the network re-entry information, through the ACK channel in response to the ACK request information.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram schematically illustrating a configuration of a general IEEE 802.16e communication system;

FIG. 2 is a flow diagram illustrating a network re-entry process with a target BS upon occurrence of handover in a general IEEE 802.16e communication system;

FIG. 3 is a flow diagram illustrating the BW-REQ random access operation in FIG. 2;

FIG. 4 is a flow diagram illustrating a network re-entry process upon occurrence of handover in an IEEE 802.16e communication system according to an embodiment of the present invention;

FIG. 5 is a diagram schematically illustrating an authorization operation state diagram of an MSS in an IEEE 802.16e communication system according to an embodiment of the present invention;

FIG. 6 is a diagram schematically illustrating a header structure of a MAC message in an IEEE 802.16e communication system according to an embodiment of the present invention;

FIG. 7 is a diagram schematically illustrating a resource allocation structure for transmitting an MM-ACK message in an IEEE 802.16e communication system according to an embodiment of the present invention;

FIG. 8 is a flowchart illustrating a process of transmitting an MM-ACK message by an MSS in an IEEE 802.16e communication system according to an embodiment of the present invention;

FIG. 9 is a flowchart illustrating a process of receiving an MM-ACK message by a BS in an IEEE 802.16e communication system according to an embodiment of the present invention;

FIG. 10 is a flow diagram illustrating a process of retransmitting a MAC message in a network re-entry operation upon occurrence of handover in an IEEE 802.16e communication system according to an embodiment of the present invention,

FIG. 11 is a diagram schematically illustrating a format of the MAC message A of FIG. 10;

FIG. 12 is a diagram schematically illustrating a format of the MM-ACK_A message of FIG. 10;

FIG. 13 is a diagram schematically illustrating a format of the MAC message_B of FIG. 10;

FIG. 14 is a diagram schematically illustrating a format of the MM-ACK_B message of FIG. 10;

FIG. 15 is a diagram schematically illustrating a format of the MAC message_C of FIG. 10; and

FIG. 16 is a diagram schematically illustrating a format of the MM-ACK_C message of FIG. 10.

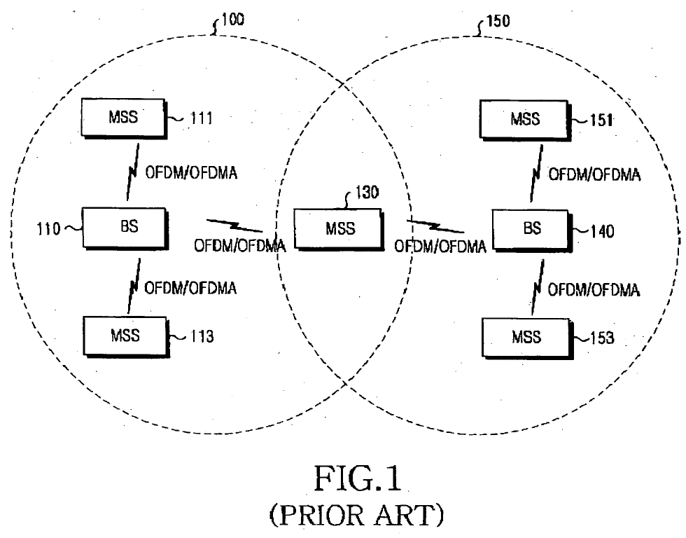

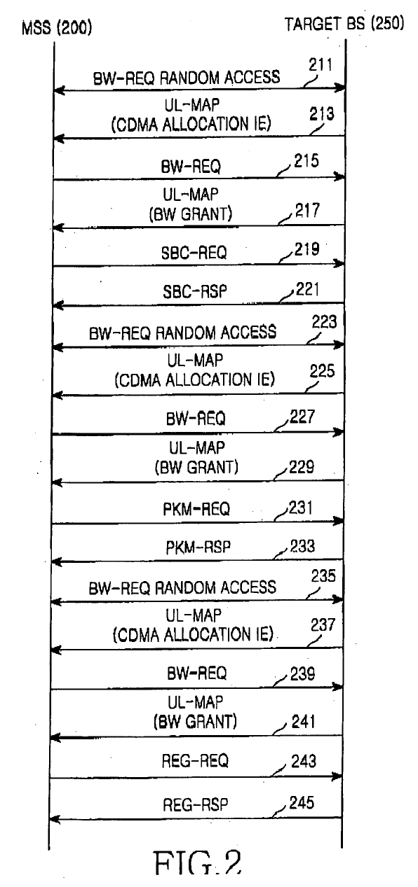

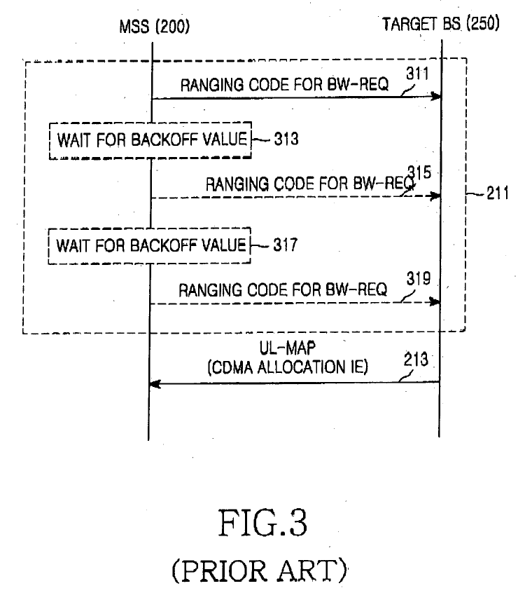

### DETAILED DESCRIPTION OF THE PREFERRED EMBODIMENT

A preferred embodiment of the present invention will now be described in detail with reference to the annexed drawings. In the drawings, the same or similar elements are denoted by the same reference numerals even though they are depicted in different drawings. In the following description, a detailed description of known functions and configurations incorporated herein has been omitted for conciseness.

The present invention proposes a scheme of allowing a mobile subscriber station (MSS) to perform a network re-entry operation when it performs handover while performing communication in an Institute of Electrical and Electronics Engineers (IEEE) 802.16e communication system which is a Broadband Wireless Access (BWA) communication system. That is, the scheme proposed by the present invention allows an MSS to perform network re-entry with high reliability within the shortest period of time when it performs a handover during communication.

Herein, the IEEE 802.16e communication system refers to a BWA communication system using an Orthogonal Frequency Division Multiplexing (OFDM) scheme and/or an Orthogonal Frequency Division Multiple Access (OFDMA) scheme. The IEEE 802.16e communication system, as it uses the OFDM/OFDMA scheme, can enable high-speed data transmission by transmitting physical channel signals using a plurality of subcarriers. Further, the IEEE 802.16e communication system supports a multicell structure to support mobility of an MSS.

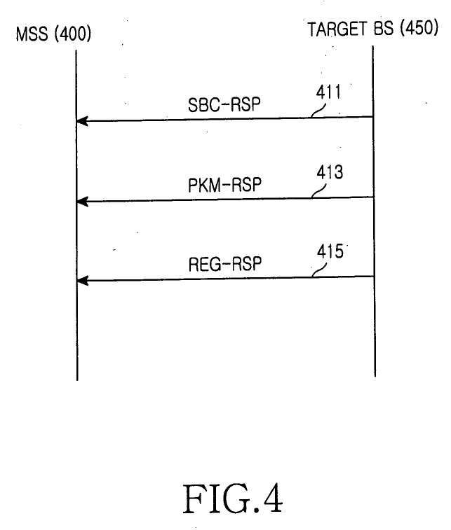

With reference to FIG. 4, a description will now be made of an operation of a network re-entry operation upon handover of an MSS in an IEEE 802.16e communication system according to an embodiment of the present invention.

FIG. 4 is a flow diagram illustrating a network re-entry process upon occurrence of handover in an IEEE 802.16e communication system according to an embodiment of the present invention. Once an MSS 400 is handed over from a serving BS to a target BS 450, the MSS 400 acquires downlink and uplink synchronizations by performing an initial ranging operation with the target BS 450. Subsequently, the target BS 450 transmits a Subscriber Station's Basic Capability Negotiation Response (SBC-RSP) message to the MSS 400 even though the MSS 400 does not separately transmit a Subscriber Station's Basic Capability Negotiation Request (SBC-REQ) message (Step 411).

In an embodiment of the present invention, in order to allow the MSS 400 to perform a network re-entry operation upon handover within the shortest period of time, the target BS 450 transmits response messages required in the MSS 400 (i.e., an SBC-RSP message), a Privacy Key Management Response (PKM-RSP) message and a Registration Response (REG-RSP) message, even though the MSS 400 does not transmit request messages (i.e., an SBC-REQ message, a Privacy Key Management Request (PKM-REQ) message and a Registration Request (REG-REQ) message), to the target BS 450.

That is, after transmitting the SBC-RSP message to the MSS 400, the target BS 450 transmits a PKM-RSP message (Step 413) and transmits REG-RSP message (Step 415), even though it does not receive separate request messages from the MSS 400.

Here, the SBC-RSP message includes information on a modulation scheme and a coding scheme supportable by the MSS 400, the PKM-RSP message includes an authentication key (AK) and a traffic encryption key (TEK) allocated to the MSS 400, and the REG-RSP message includes registration information of the MSS 400. In addition, the target BS 450 receives information included in the SBC-RSP message, PKM-RSP message and REG-RSP message from an old serving BS.

That is, as described above (in the Related Art section), in order for an MSS to perform a network re-entry operation after performing handover, the MSS should perform Bandwidth Request (BW-REQ) random access and then transmit the SBC-REQ message, PKM-REQ message and REG-REQ message. The BW-REQ random access is performed on a contention basis, thus causing an access delay which causes a delay in the network re-entry operation upon handover.

Therefore, in the present invention, even though the MSS performing handover does not transmit the SBC-REQ message, PKM-REQ message and REG-REQ message, the target BS transmits the SBC-RSP message, PKM-RSP message and REG-RSP message to the MSS, thereby eliminating or reducing a delay in a network re-entry operation.

With reference to FIG. 4, a description has been made of the network re-entry operation upon occurrence of handover in the IEEE 802.16e communication system according to an embodiment of the present invention. In order for the target BS 450 to transmit the SBC-RSP message, PKM-RSP message and REG-RSP message to the MSS 400 even through it does not receive the SBC-REQ message, PKM-REQ message and REG-REQ message from the MSS 400 as described with reference to FIG. 4, the target BS 450 should share information on the MSS 400 with a serving BS without performing a separate procedure.

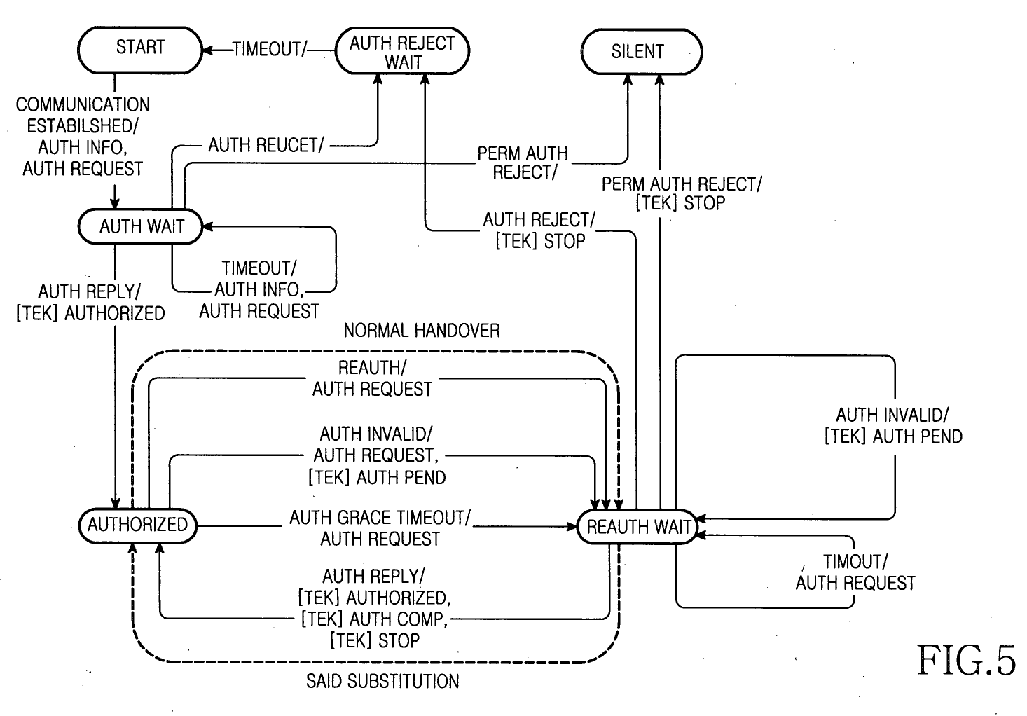

Therefore, an embodiment of the present invention newly proposed authorization operation state in order to enable the target BS 450 to transmit the PKM-RSP message to the MSS 400 even though it does not receive the PKM-REQ message from the MSS 400. Although, the newly proposed authorization operation state is almost equal in its basic operation to a general authorization operation state of the IEEE 802.16e communication system, the newly proposed authorization operation state includes a newly proposed operation for delivering authorization information to an MSS (i.e., transmitting a PKM-RSP message to the MSS), even though the MSS does not send a separate authorization request upon its handover (i.e., the MSS does not transmit a PKM-REQ message). With reference to FIG. 5, a description will now be made of an authorization operation state diagram of an MSS in an IEEE 802.16e communication system according to an embodiment of the present invention.

FIG. 5 is a diagram schematically illustrating an authorization operation state diagram of an MSS in an IEEE 802.16e communication system according to an embodiment of the present invention. Before a description of FIG. 5 is given, it should be noted that the authorization operation state proposed in the present invention enables, upon occurrence of handover, an authorization operation state of an MSS to transition from an authorized (AUTHORIZED) state to a reauthorization wait (REAUTH WAIT) state without transmission of an authorization request (AUTH REQUEST) message (i.e., without transmission of the PKM-REQ message), thereby enabling a target BS to perform reauthorization operation. Therefore, an MSS performing a network re-entry operation upon handover can receive a PKM-RSP message from a target BS even though it does not transmit a contention-based PKM-REQ message, reducing or minimizing a network re-entry time. It should be noted that a plurality of states in the new authorization operation state, illustrated in FIG. 5, are equal to the states in the general authorization operation state of the IEEE 802.16e communication system, and they are different from each other only in operations caused by handover.

Referring to FIG. 5, a start (START) state is an initial state of the authorization operation state, and in the START state, no resource is allocated or used. In this state, if the MSS completes a Subscriber Station's Basic Capability Negotiation procedure with a serving BS by transmitting/receiving SBC-REQ/SBC-RSP messages, a COMMUNICATION ESTABLISHMENT event occurs. If the COMMUNICATION ESTABLISHMENT event happens, the MSS transmits authorization information (AUTH INFORMATION) and an AUTH REQUEST message to the serving BS, and then transitions to an authorization wait (AUTH WAIT) state where it waits for a response from the serving BS. Here, the authorization information includes a key which is uniquely allocated at the time when the MSS was manufactured, and can be used to distinguish the MSS, and the AUTH REQUEST message is a message with which the MSS requests the serving BS for authorization.

In the AUTH WAIT state, if the MSS receives an authorization reply (AUTH REPLY) message including an authentication key (AK) from the serving BS, the MSS transitions from the AUTH WAIT state to an AUTHORIZED state. In the AUTH WAIT state, if the MSS fails to receive the AUTH REPLY message for a predetermined time (Timeout), the MSS retransmits the transmitted authorization information and AUTH REQUEST message to the serving BS, and then transitions to the AUTH WAIT state. In the AUTH WAIT state, if the MSS receives an authorization reject (AUTH REJECT) message from the serving BS in response to the AUTH REQUEST message, the MSS transitions to an authorization reject wait (AUTH REJECT WAIT) state where it waits for a predetermined time, and then transitions to the START state.

The AUTHORIZED state is a state in which the MSS has successfully received an authentication key. The MSS should always receive a new authentication key upon its reauthorization request or before timeout of a life time of an authentication key currently in use. Therefore, if a predetermined authorization grace time is timeouted (AUTH GRACE TIMEOUT), the MSS transitions to a reauthorization wait (REAUTH WAIT) state when transmitting the AUTH REQUEST message.

The REAUTH WAIT state is a state to which the MSS transitions each time it requests reauthorization in the AUTHORIZED state. In the REAUTH WAIT state, if the MSS fails to receive an AUTH REPLY message for a predetermined time, the MSS retransmits the AUTH REQUEST message to the serving BS, and then stays in the REAUTH WAIT state. In the REAUTH WAIT state, if the MSS receives the AUTH REPLY message from the serving BS, the MSS transitions to the AUTHORIZED state.

In the REAUTH WAIT state, if an AUTH REQUEST message or an AUTH REJECT message received from the serving BS is invalid, the MSS transmits the authentication key used for authorization, and then transitions to the REAUTH WAIT state. The AUTH REJECT message includes an authorization reject cause in an error code before being transmitted, and when the error code represents a permanent cause, the MSS transitions to a silent (SILENT) state. However, if the error code does not represent a permanent cause, the MSS transitions to the AUTH REJECT WAIT state.

In the SILENT state, although the MSS cannot exchange data with the serving BS, the MSS can transmit a control response message in response to a permanent AUTH REJECT message received from the serving BS.

An operation of an MSS in the new authorization operation state described above is equivalent to an operation of an MSS in the general authorization operation state of the IEEE 802.16e communication system. That is, generally, an MSS performing communication with a serving BS stays in the AUTHORIZED state. In the AUTHORIZED state, if the MSS performs handover, the MSS releases a connection to the serving BS by transmitting a Handover Indication (HO-IND) message to the serving BS, and then sets up a new connection to a target BS. In this process, the MSS performs a reauthorization operation with the target BS, and this operation is achieved through a PKM-REQ message and a PKM-RSP message. Here, because the information transmitted to the target BS through the PKM-REQ message can be delivered from the serving BS to the target BS, the MSS is not required to separately transmit the PKM-REQ message. In addition, because an authentication key (AK) and a plurality of traffic encryption keys (TEKs), which were used by the serving BS and the MSS, can also be delivered from the serving BS to the target BS, the MSS is not required to separately transmit the PKM-REQ message to the target BS.

In order to reuse the authentication key and the plurality of traffic encryption keys, a Security Association Identifier (SAID) used between the MSS and the serving BS to manage the authentication key and the plurality of traffic encryption keys should be substituted with a SAID that can be used in the MSS and the target BS. The substitution of the SAID can be notified in such a manner that the target BS includes SAID substitution information in the PKM-RSP message shown in Table 1 and then transmits the PKM-RSP message to the MSS.

TABLE 1

| Syntax | | Size | |
|---|---|---|---|
| PKM-RSP(SAID substitution) Message_Format ( ) { | | | |
| | Management Message Type=9 | 8 | bits |
| | PKM message code = 15 | 8 | bits |
| | PKM Identifier=0x00 | 8 | bits |
| | Number of SAID substitution | | |
| | For (j=0: j<Number of SAID substitution: j++) { | | |

| | | |
|---|---|---|
| Old SAID | 16 | bits |
| New SAID | 16 | bits |

}

}

In Table 1, a Management Message Type field includes information on a type of a transmission message, and in the embodiment of the present invention, the Management Message Type is set to 9 to indicate the PKM-RSP message. A PKM message code field includes information on a type of the PKM message. The PKM message code field can have a plurality of code values, and particularly, in order to indicate SAID substitution according to an embodiment of the present invention, a random code currently not in use, for example, 15, among general PKM message codes of the PKM-RSP message is written in the PKM message code field. A PKM identifier field is an identifier to be managed in pair together with a PKM-REQ message transmitted by an MSS, and in the embodiment of the present invention, because the MSS does not transmit the PKM-REQ message to the target BS, the PKM identifier field has a value 0. A “Number of SAID substitution field” is a field newly proposed in the present invention, and indicates the number of pairs of old SAIDs previously used in the serving BS and new SAIDs to be substituted for the old SAIDs in the target BS. That is, in Table 1, if the PKM message code field is represented by a value 15, the MSS recognizes that the SAID is substituted as the MSS is handed over from the serving BS to the target BS, and can also recognize the old SAID and the new SAID included in the Number of SAID substitution field.

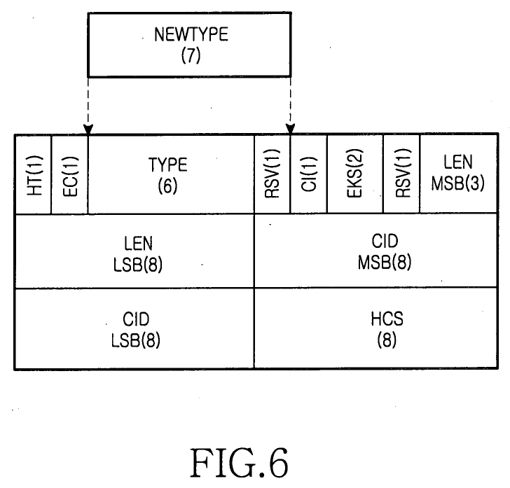

With reference to FIG. 5, a description has been made of the authorization operation state of the IEEE 802.16e communication system according to an embodiment of the present invention. Next, with reference to FIG. 6, a description will be made of a header structure of a Medium Access Control (MAC) message in an IEEE 802.16e communication system according to an embodiment of the present invention.

FIG. 6 is a diagram schematically illustrating a header structure of a MAC message in an IEEE 802.16e communication system according to an embodiment of the present invention. Before a description of FIG. 6 is given, it should be noted that a MAC message used in the IEEE 802.16e communication system includes a MAC header field and a Management Payload field, and the embodiment of the present invention newly proposes the MAC header field.

Referring to FIG. 6, the MAC header field includes a 1-bit Header Type (HT) field, a 1-bit Encryption Control (EC) field, a 6-bit TYPE field, a 1-bit Reserved (RSV) field, a 1-bit CRC Indicator (CI) field, a 2-bit Encryption Key Sequence (EKS) field, a 1-bit RSV field, a 3-bit Length Most Significant (LEN MSB) field, an 8-bit Length Least Significant (LEN LSB) field, an 8-bit Connection Identifier (CID) MSB field, an 8-bit CID LSB field, and an 8-bit Header Check Sequence (HCS) field. Here, respective fields of the MAC header have the values illustrated in Table 2.

TABLE 2

| | Length | |
|---|---|---|
| Name | (bits) | Description |
| HT | 1 | Header Type. |
| | | 0 = Generic MAC Header |
| | | 1 = Bandwidth Request Header |
| EC | 1 | Encryption Control |
| | | 0 = Payload is not encrypted |
| | | 1 = Payload is encrypted |
| Type | 6 | This field indicates the |
| | | payload type |
| Rsv | 2 | Reserved |
| CI | 1 | CRC Indicator |
| EKS | 2 | Encryption Key Sequence |
| | | The index of the Traffic Encryption |
| | | Key and Initialization Vector |
| | | used to encrypt the payload. This |
| | | field is only meaning of the |
| | | Encryption Control field is set |
| | | to 1. |
| LEN | 11 | The length in bytes of the MAC |
| | | PDU including the MAC |
| | | header. |
| CID | 16 | Connection Identifier |
| HCS | 8 | An 8-bit field used to detect |
| | | errors in the header. |

The foregoing MAC header field is equal to a general MAC header field of the IEEE 802.16e communication system, and the embodiment of the present invention proposes a new 7-bit NEW TYPE field by combining the 6-bit TYPE filed with the 1-bit RSV field. The 7-bit NEW TYPE field proposed in the present invention is illustrated in Table 3.

TABLE 3

| Type bit | Value |
|---|---|
| #6 (MSB) | Mesh subheader |
| #5 | ARQ Feedback Payload |
| #4 | Extended Type |
| #3 | Fragmentation subheader |
| #2 | Packing subheader |
| #1 | Grant Management subheader (uplink) or |
| | ARQ_ACK allocation subheader (downlink) |
| #0 (LSB) | Management Message ACK allocation subheader |
| | 1 = present, 0 = absent |

As illustrated in Table 3, values of respective bits in the NEW TYPE field represent the presence/absence of a plurality of subheaders. Here, the respective subheaders can be included in the MAC message when necessary, and play different roles. A description will now be made of the respective bits of the NEW TYPE field.

First, a bit #6, the most significant bit (MSB), is a bit indicating the presence/absence of a Mesh subheader field, and is always used when network architecture is in a Mesh mode wherein the term Mesh mode is defined in the IEEE 802.16e standard.

Second, a bit #5 is a bit indicating the presence/absence of an Automatic Retransmission Request (ARQ) Feedback Payload field, and the ARQ Feedback Payload field includes ACK information for each connection.

Third, a bit #4 is a bit indicating the presence/absence of an Extended Type field. If the bit #4 is represented by 1, it means that an ARQ scheme should be applied to a corresponding connection, and if the bit #4 is represented by 0, it means that it is not necessary to apply the ARQ scheme to the corresponding connection.

Fourth, a bit #3 is a bit indicating the presence/absence of a Fragmentation subheader field. Fragmentation subheader is used to fragmentize one MAC-SDU into a plurality of MAC-PDUs, and includes fragmentation information. Here, the packing subheader and the fragmentation subheader both include sequence information, and the sequence information is used to apply the ARQ scheme upon packet loss.

Fifth, a bit #2 is a bit indicating the presence/absence of a Packing subheader field. The Packing subheader is used to distinguish MAC-SDUs (Service Data Units) in order to generate one MAC-PDU (Protocol Data Unit) by packing a plurality of the MAC-SDUs.

Sixth, a bit #1 indicates the presence/absence of a Grant Management subheader field for an uplink, and indicates the presence/absence of an ARQ_ACK allocation subheader field for a downlink. Here, the Grant Management subheader is used when the MSS requests a BS for a bandwidth. In addition, the ARQ_ACK allocation subheader is used to indicate transmission of ACK information for a corresponding MAC message in a position indicated by a position field in the ARQ_ACK allocation header.

Finally, a bit #0, the least significant bit (LSB), is a bit indicating the presence/absence of a Management Message ACK Allocation Subheader (MMAASH) field. If the bit #0 is set to 1, it means that an MMAASH field illustrated in Table 4 is concatenated to the MAC header field of the MAC message.

TABLE 4

| Syntax | Size |
|---|---|
| M²A²SH Format ( ) { | |

| | |
|---|---|
| Frame offset | 2 bits |
| Allocation offset | 6 bits |
| No. of Allocation Slots | 8 bits |

}

In Table 4, Frame Offset represents an offset from a frame over which an MMAASH is transmitted, to a frame where resource allocation for ACK transmission is achieved. Allocation Offset filed represents an offset from a start point of an ACK channel interval allocated to a burst profile for which an Uplink Interval Usage Code (UIUC) in a UL-MAP message is set to 0. “No. of Allocation Slots” filed represents the number of slots allocated for ACK transmission by the MSS.

The MMAASH is equal in operation to a general ARQ_ACK allocation subheader in the IEEE 802.16e communication system. However, the proposed MMAASH is different from the general ARQ_ACK allocation subheader in that the MMAASH is used for a management message to which the ARQ scheme is not applied, and additionally includes the No. of Allocation Slots field. That is, because a Management Message-Acknowledge (MM-ACK) message described below or the ARQ_ACK message is variable in length, a scheduler of a BS informs the MSS of the amount of resources allocated to ACK channels through the No. of Allocation Slots field, considering the number of MAC-PDUs waiting for reception of an ACK message.

In an ACK channel allocated to the UL-MAP's UIUC=0 burst profile, a format of the MM-ACK message transmitted in a position indicated by the MMAASH is illustrated in Table 5.

TABLE 5

| Syntax | Size |
|---|---|
| MM_ACK Message_Format ( ) { | |

| | |
|---|---|
| Reserved | 6 bits |
| Number of ACK Maps | 2 bits |
| For (j=0: j<Number of ACK Maps; j++) { | |

| | |
|---|---|
| Message Type | 8 bits |
| ACK Map | 8 bits |

}

}

In Table 5, a Reserved field is a field reserved for future use, and a Number of ACK Maps field is a field indicating the number of ACK Maps to be allocated, which will be described below. Here, the ACK Map field includes an 8-bit Message Type field and an 8-bit Fragment Sequence Number (FSN) Map field. The Message Type field indicates a type of a management message, an ACK for which should be transmitted, and the FSN Map field is a bitmap and indicates whether a MAC-PDU with FSN=0-7 for MSB to LSB is received. That is, if MSB is 0, it means that a MAC-PDU with FSN=0 is not received, and if LSB is 1, it means that a MAC-PDU with FSN=7 is normally received. If there is an ACK for a non-fragmentized management message, the FSN Map is represented by 11111111 (binary). Preferably, the MM-ACK message illustrated in Table 5 is transmitted as a separate message, instead of being included in another transmission message.

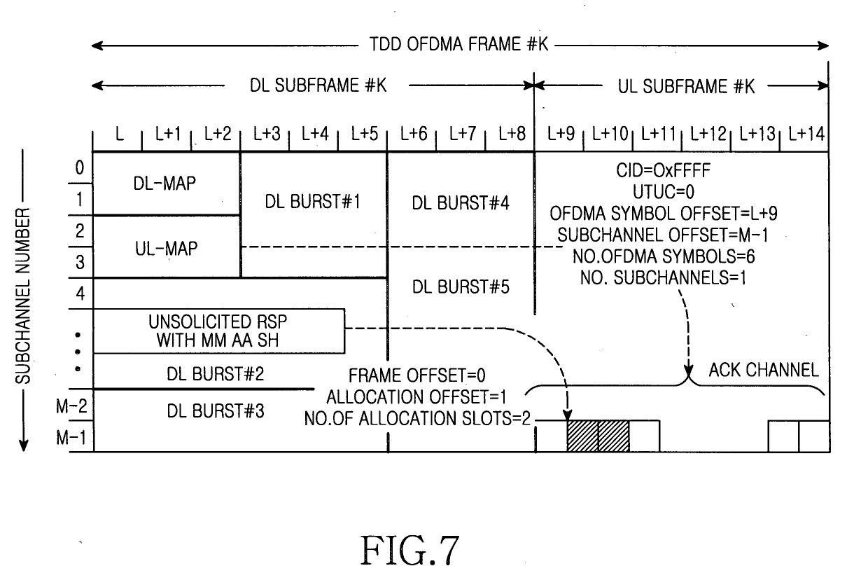

With reference to FIG. 7, a description will now be made of a resource allocation structure for transmitting the MM-ACK message in an IEEE 802.16e communication system.

FIG. 7 is a diagram schematically illustrating a resource allocation structure for transmitting an MM-ACK message in an IEEE 802.16e communication system according to an embodiment of the present invention. Before a description of FIG. 7 is given, it should be noted that a scheme defined by applying a Time Division Duplexing (TDD) scheme to the OFDMA scheme is referred to as a TDD OFDMA scheme, and when data is transmitted using the TDD OFDMA scheme, each of OFDM symbols is transmitted through a plurality of subcarriers (i.e., predetermined subchannels, created in the IEEE 802.16e communication system). Here, the term “subchannel” refers to a channel including predetermined number of subcarriers according to predetermined settings of the IEEE 802.16e communication system.

A BS creates a downlink subframe and an uplink subframe with a predetermined number of subchannels and OFDM symbols. A frame structure created using the OFDM scheme is different from a frame structure created using the OFDMA scheme in that one MSS uses the entire subcarrier interval in a particular OFDM symbol. In addition, the frame structure created using the OFDM scheme is different from the frame structure created using the OFDMA scheme in that a frame structure and multiple carriers (MC) created using a single carrier (SC) scheme are used.

Referring to FIG. 7, a horizontal axis represents an OFDM symbol number and a vertical axis represents a subchannel number. As illustrated in FIG. 7, one OFDMA frame includes a downlink subframe including a plurality of, (e.g., 9 OFDM symbols), and an uplink subframe including a plurality of, (e.g., 6 OFDM symbols). Each of the OFDM symbols includes a plurality of, subchannels (e.g., M subchannels). In the downlink subframe structure, each OFDMA frame includes a DL-MAP message and a UL-MAP message.

In FIG. 7, an ACK channel with a UIUC=0 burst profile is allocated to all OFDM symbols of a subchannel #(M-1) through the UL-MAP message in a current uplink subframe. In addition, an MMAASH is included in a management message unicast through a downlink (i.e., MAC message), before being transmitted, and a second ACK slot or a third ACK slot in an ACK channel allocated to a current frame is used for the MMAASH. It will be assumed herein that one ACK slot has the same time interval as that of one OFDM symbol.

When the MSS normally receives the MAC message, the MSS can transmit an MM-ACK message through an ACK slot in the ACK channel, allocated thereto. However, when the MSS fails to normally receive the MAC message, the MSS cannot transmit the MM-ACK message. When the BS fails to receive an MM-ACK message from the MSS at a corresponding ACK slot after transmitting the MAC message, the BS recognizes that the MSS has failed to normally receive the MAC message, and retransmits the MAC message to the MSS.

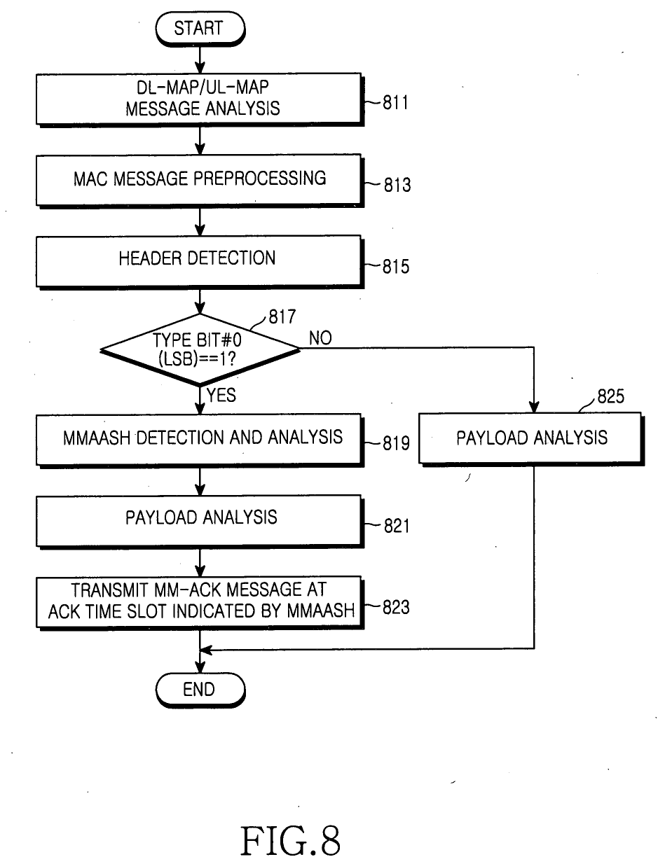

With reference to FIG. 7, a description has been made of the resource allocation structure for MM-ACK message transmission in an IEEE 802.16e communication system according to an embodiment of the present invention. Next, with reference to FIG. 8, a description will be made of an operation of transmitting an MM-ACK message by an MSS according to an embodiment of the present invention.

FIG. 8 is a flowchart illustrating a process of transmitting an MM-ACK message by an MSS in an IEEE 802.16e communication system according to an embodiment of the present invention. In step 811, an MSS receives a DL-MAP message and a UL-MAP message from a BS. Subsequently, the MSS determines a position of its own information transmitted from the BS by analyzing the received DL-MAP message and UL-MAP message. In addition, the MSS determines whether an ACK slot is allocated thereto, and if the ACK slot is allocated thereto, the MSS analyzes information on a position of the allocated ACK slot. Thereafter, in step 813, the MSS receives only the MAC message targeting the MSS itself using the analysis result of the DL-MAP message, and performs preprocessing such as error checking and decoding on the received MAC message. In step 815, the MSS detects a MAC header form the preprocessed MAC message, and then proceeds to step 817.

In step 817, the MSS determines whether a bit #0, which is an LSB of a NEW TYPE field in the MAC header, has a value of 1 (NEW TYPE BIT #0 (LSB=1). If it is determined that the bit #0, which is an LSB of a NEW TYPE field in the MAC header, does not have a value of 1, the MSS proceeds to step 825. In step 825, the MSS analyzes the received MAC message in the conventional manner, determining that there is no MMAASH included in the MAC message, and then ends its operation.

However, if it is determined in step 817 that the bit #0, which is an LSB of a NEW TYPE field in the MAC header, has a value of 1, the MSS proceeds to step 819. In step 819, determining that there is an MMAASH included in the MAC message, the MSS detects and analyzes the MMAASH and then proceeds to step 821. In step 821, the MSS analyzes the received MAC message, and then proceeds to step 823. In step 823, the MSS transmits an MM-ACK message at the ACK time slot designated by the MMAASH, and then ends its operation.

With reference to FIG. 8, a description has been made of an operation of transmitting an MM-ACK message by an MSS in an IEEE 802.16e communication system according to an embodiment of the present invention. Next, a description will be made of an operation of receiving an MM-ACK message by a BS in an IEEE 802.16e communication system according to an embodiment of the present invention.

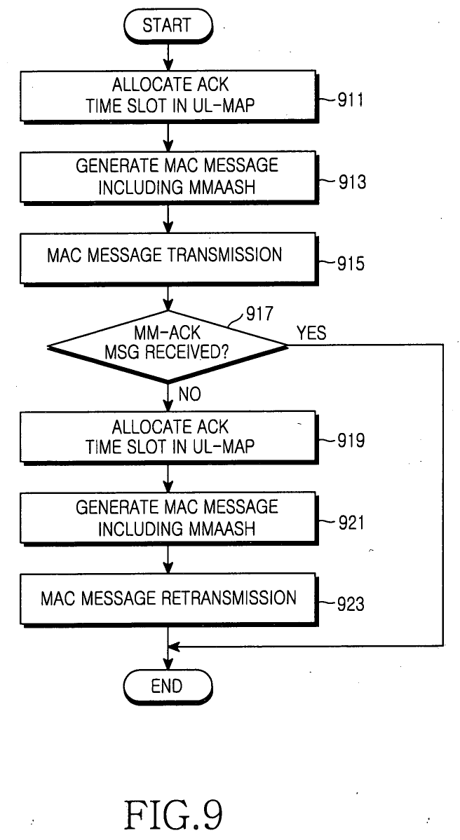

FIG. 9 is a flowchart illustrating a process of receiving an MM-ACK message by a BS in an IEEE 802.16e communication system according to an embodiment of the present invention. In step 911, a BS allocates an ACK time slot so that an MSS can transmit an MM-ACK message, and includes information on the allocated ACK time slot in a UL-MAP message before transmission. In step 913, the BS generates a MAC message including the MMAASH, and then proceeds to step 915. Here, the MMAASH, as described above, includes information on an ACK time slot at which the MSS transmits the MM-ACK message.

In step 915, the BS transmits the generated MAC message to the MSS, and then proceeds to step 917. In step 917, the BS determines whether an MM-ACK message is received from the MSS at the ACK time slot allocated to the MMAASH. If it is determined that an MM-ACK message is received from the MSS at the ACK time slot allocated to the MMAASH, the BS ends its operation, determining that the transmitted MAC message has been normally received at the MSS.

However, if it is determined in step 917 that an MM-ACK message is not received from the MSS at the ACK time slot allocated to the MMAASH, the BS proceeds to step 919. In step 919, the BS reallocates an ACK time slot so that the MSS can transmit an MM-ACK message, and then includes information on the allocated ACK time slot in a UL-MAP message before transmission. In step 921, the BS re-generates a MAC message including the MMAASH, and then proceeds to step 923. Here, the MMAASH, as described above, includes information on an ACK time slot at which the MSS transmits the MM-ACK message. In step 923, the BS retransmits the re-generated MAC message, and then ends its operation.

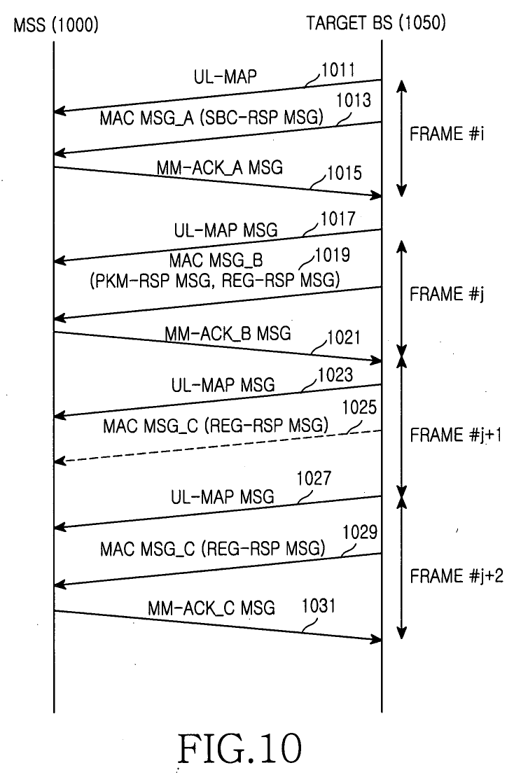

With reference to FIG. 9, a description has been made of an operation of receiving an MM-ACK message by a BS in an IEEE 802.16e communication system according to an embodiment of the present invention. Next, with reference to FIG. 10, a description will be made of an operation of retransmitting a MAC message in a network re-entry operation upon occurrence of handover in an IEEE 802.16e communication system according to an embodiment of the present invention.

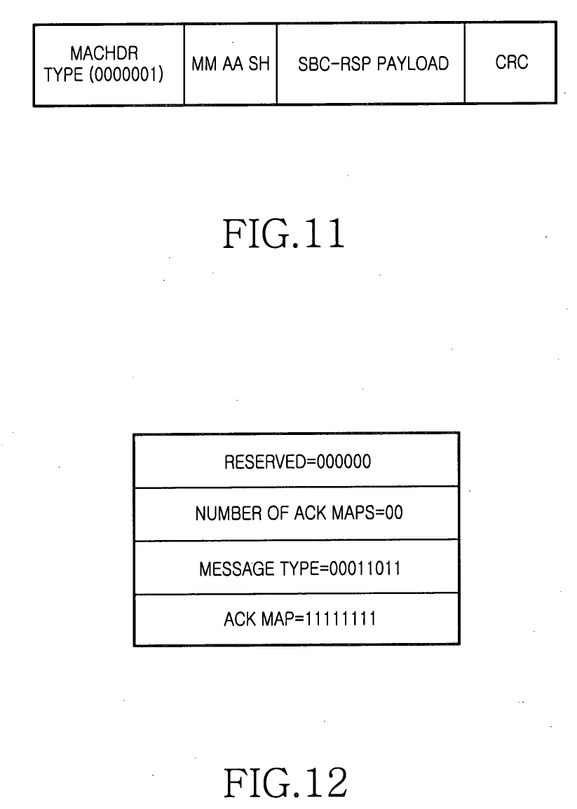

FIG. 10 is a flow diagram illustrating a process of retransmitting a MAC message in a network re-entry operation upon occurrence of handover in an IEEE 802.16e communication system according to an embodiment of the present invention. A target BS 1050 allocates an ACK time slot so that an MSS 1000 can transmit an MM-ACK message, and transmits a UL-MAP message including information on the ACK time slot (Step 1011). Thereafter, the target BS 1050 includes an MMAASH in a MAC message_A and transmits the MAC message_A to the MSS 1000 (Step 1013). Here, an MMAASH is included in the MAC message_A such that the MM-ACK message can be transmitted through an ACK time slot of an ACK channel defined in the same frame as the frame through which the MAC message_A is transmitted. In addition, the MAC message_A includes an SBC-RSP message, and a format of the MAC message_A will be described below with reference to FIG. 11.

FIG. 11 is a diagram schematically illustrating a format of the MAC message_A of FIG. 10. The MAC message_A includes a MAC Header field, an MMAASH field, an SBC-RSP PAYLAOD field, and a CRC (Cyclic Redundancy Check) field. Here, because the MAC message_A includes the MMAASH field, a Type value of the MAC Header field (i.e., a NEW TYPE value), is represented by 0000001(binary). Although not illustrated in FIG. 11, a Frame Offset field in the MMAASH field is represented by 00 so that the MSS 1000 transmits an MM-ACK message (i.e., an MM-ACK_A message using an ACK channel allocated to a frame through which the MAC message_A is transmitted). Here, the MM-ACK_A message represents an MM-ACK message for the MAC message_A.

Upon normally receiving the MAC message_A from the target BS 1050, the MSS 1000 transmits an MM-ACK_A message to the target BS 1050 at the ACK time slot designated by an MMAASH in the MAC message_A in order to inform the target BS 1050 of its normal receipt of the MAC message_A (Step 1015). A format of the MM-ACK_A message will be described with reference to FIG. 12.

FIG. 12 is a diagram schematically illustrating a format of the MM-ACK_A message of FIG. 10. The MM-ACK_A message means a message used by the MSS 1000 to inform the target BS 1050 of its normal receipt of the MAC message_A, and includes a Reserved field, a Number of ACK MAPs field, a Message Type field, and an ACK MAP field. Here, the Number of ACK MAPs field is represented by 00, the Message Type field is represented by 00011011 and the ACK MAP field is represented by 11111111 to inform the target BS 1050 that the MM-ACK_A message includes an ACK MAP field for the MAC message_A and the MSS 1000 has successful received a MAC message_A with Message Type=27 (i.e., an SBC-RSP message).

If the Number of ACK MAPs field illustrated in FIG. 12 is set to 00, it means one transmission of the MAC message_A illustrated in FIG. 11. If the Number of ACK MAPs field is set to 01, it means two transmissions of the MAC message_A. If the Number of ACK MAPs field is set to 10, it means three transmissions of the MAC message_A. If the Number of ACK MAPs field is set to 11, it means four transmissions of the MAC message_A.

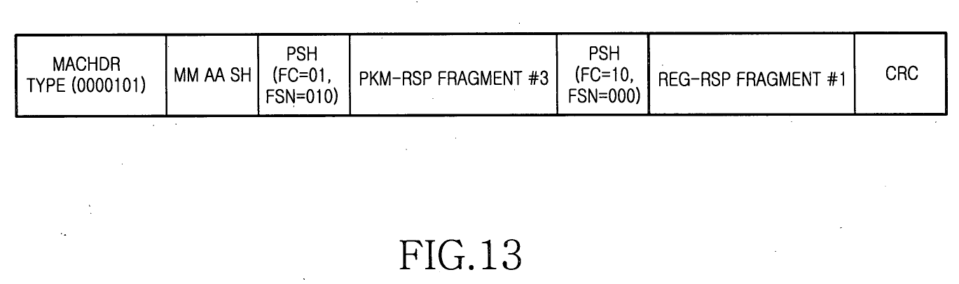

Upon receiving the MM-ACK_A message, the target BS 1050 allocates an ACK time slot so that the MSS 1000 can transmit an MM-ACK message, determining that the MSS 1000 has normally received the transmitted MAC message_A, and then transmits a UL-MAP message including information on the ACK time slot (Step 1017). Thereafter, the target BS 1050 includes an MMAASH in a MAC message_B and transmits the MAC message_B to the MSS 1000 (Step 1019). Here, the MAC message_B also includes the MMAASH so that the MM-ACK message can be transmitted through an ACK time slot of an ACK channel defined in the same frame as the frame through which the MAC message_B is transmitted. In addition, the MAC message_B includes a PKM-RSP message and an REG-RSP message, and a format of the MAC message_B will be described with reference to FIG. 13.

FIG. 13 is a diagram schematically illustrating a format of the MAC message_B of FIG. 10. The MAC message_B includes a MAC Header field, an MMAASH field, a PSH (Packing Subheader) field, a PKM-RSP Payload (PKM-RSP FRAGMENT #3) field, a PSH field, a REG-RSP Payload (REG-RSP FRAGMENT #1) field, and a CRC field. Here, a Type value of the MAC Header field (i.e., a NEW TYPE value), is represented by 0000101 in order to indicate that the MAC message_B includes the MMAASH field and is a MAC message generated by packing a PKM-RSP message and a REG-RSP message. In addition, because the PKM-RSP message and the REG-RSP message packed in the MAC message_B are fragmentized messages (i.e., because the PKM-RSP message is a third message among the fragmentized messages and the REG-RSP message is a first message among the fragmentized messages), an FC value and an FSN value of each PSH are set as shown in FIG. 13.

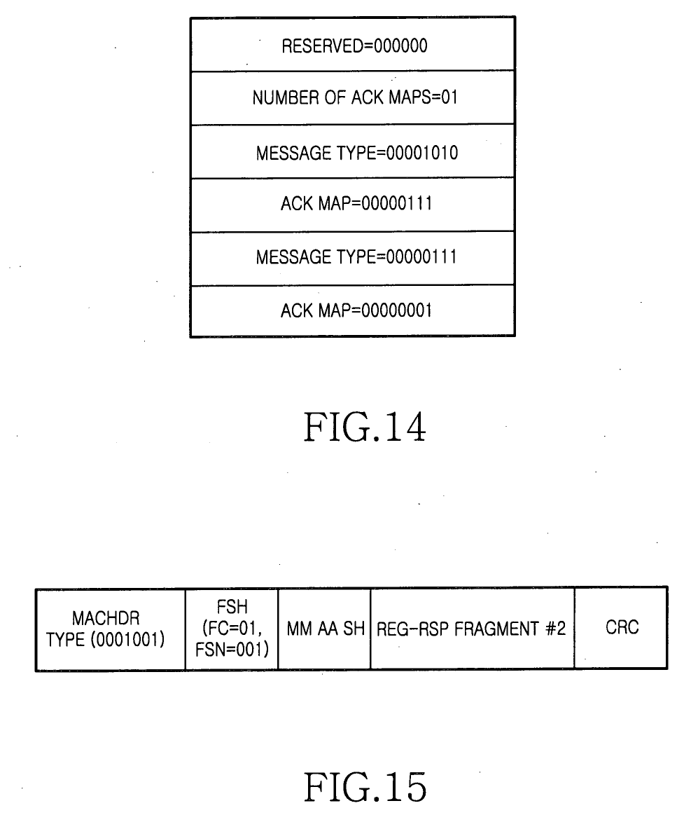

Upon normally receiving the MAC message_B from the target BS 1050, the MSS 1000 transmits an MM-ACK_B message to the target BS 1050 at the ACK time slot designated by an MMAASH in the MAC message_B in order to inform the target BS 1050 of its normal receipt of the MAC message_B (Step 1021). A format of the MM-ACK_B message will be described with reference to FIG. 14.

FIG. 14 is a diagram schematically illustrating a format of the MM-ACK_B message of FIG. 10. The MM-ACK_B message is a message used by the MSS 1000 to inform the target BS 1050 of its normal receipt of the MAC message_B, and includes a Reserved field, a Number of ACK MAPs field, a Message Type field, an ACK MAP field, a Message Type field, and an ACK MAP field. Here, the Number of ACK MAPs field is represented by 01 to indicate that the MM-ACK_B message includes two Message Type fields and two ACK MAP fields. The first Message Type field is represented by 00001010 and the first ACK MAP field is represented by 00000111 to inform the target BS 1050 that the MSS 1000 has successfully received a MAC message_B with Message Type=10 (i.e., a PKM-RSP message), and the second Message Type field is represented by 00000111 and the second ACK MAP field is represented by 00000001 to inform the target BS 1050 that the MSS 1000 has successfully received a MAC message_B with Message Type=7 (i.e., a REG-RSP message).

Upon receiving the MM-ACK_B message, the target BS 1050 allocates an ACK time slot so that the MSS 1000 can transmit an MM-ACK message, determining that the MSS 1000 has normally received the transmitted MAC message_B, and then transmits a UL-MAP message including information on the ACK time slot (Step 1023). Thereafter, the target BS 1050 includes an MMAASH in a MAC message_C and transmits the MAC message_C to the MSS 1000 (Step 1025). Here, the MAC message_C also includes the MMAASH so that the MM-ACK message can be transmitted through an ACK time slot of an ACK channel defined in the same frame as the frame through which the MAC message_C is transmitted. In addition, the MAC message_C includes an REG-RSP message, and a format of the MAC message_C will be described with reference to FIG. 15.

FIG. 15 is a diagram schematically illustrating a format of the MAC message_C of FIG. 10. The MAC message_C includes a MAC Header field, a PSH (Packing Subheader) field, an MMAASH field, an REG-RSP Payload (REG-RSP FRAGMENT #2) field, and a CRC field. Here, a Type value of the MAC Header field (i.e., a NEW TYPE value), is represented by 0001001 in order to indicate that the MAC message_C includes the MMAASH field and is a MAC message generated including a fragmentized REG-RSP message. In addition, because the REG-RSP message included in the MAC message_C is the second, or the last, message among the fragmentized messages, an FC value and an FSN value in the PSH are set as shown in FIG. 15.

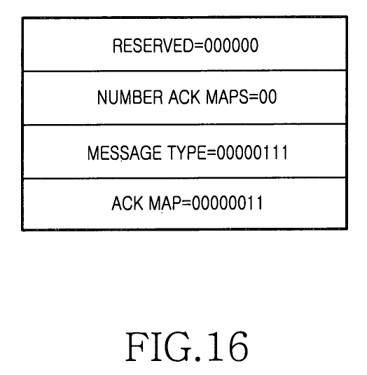

After transmitting the MAC message_C, if the target BS 1050 fails to receive an MM-ACK_C message from the MSS 1000 at a corresponding ACK time slot in response to the MAC message_C, the target BS 1050 recognizes that the MSS 1000 has failed to normally receive the MAC message_C. Therefore, the target BS 1050 allocates an ACK time slot so that the MSS 1000 can transmit an MM-ACK message, and transmits a UL-MAP message including information on the ACK time slot (Step 1027). Thereafter, the target BS 1050 retransmits the MAC message_C to the MSS 1000 (Step 1029). Upon normally receiving the MAC message_C from the target BS 1050, the MSS 1000 transmits an MM-ACK_C message to the target BS 1050 at the ACK time slot designated by the MMAASH in the MAC message_C in order to inform the target BS 1050 of its normal receipt of the MAC message_C (Step 1031). A format of the MM-ACK_C message will be described with reference to FIG. 16.

FIG. 16 is a diagram schematically illustrating a format of the MM-ACK_C message of FIG. 10. The MM-ACK_C message is a message used by the MSS 1000 to inform the target BS 1050 of its normal receipt of the MAC message_C, and includes a Reserved field, a Number of ACK MAPs field, a Message Type field, and an ACK MAP field. Here, the Number of ACK MAPs field is represented by 00, the Message Type field is represented by 00000111 and the ACK MAP field is represented by 00000011 to inform the target BS 1050 that the MM-ACK_C message includes an ACK MAP field for the MAC message_C and the MSS 1000 has successfully received a MAC message_C with Message Type=7 (i.e., a REG-RSP message).

As described above, in the BWA communication system, when an MSS performs a network re-entry operation with a target BS upon its handover, the target BS provides network re-entry information required for the network re-entry operation to the MSS without a separate request, thereby minimizing a network re-entry implementation time. The minimization of the network re-entry implementation time results in minimization in time required for connecting a service upon occurrence of handover, thereby contributing to improvement of QoS. In addition, the MSS receives separate response information for the network re-entry information, enabling a reliable network re-entry operation.

While the invention has been shown and described with reference to a certain preferred embodiment thereof, it will be understood by those skilled in the art that various changes in form and details may be made therein without departing from the spirit and scope of the invention as defined by the appended claims.

1. A method for performing network re-entry with a mobile subscriber station (MSS) by a target base station (BS) when the MSS is handed over to the target BS among a plurality of neighbor BSs, in a Broadband Wireless Access (BWA) communication system including the MSS, a serving BS providing a service to the MSS, and the plurality of neighbor BSs being different from the serving BS, the method comprising the steps of:
upon detecting handover of the MSS, detecting network re-entry information necessary for network re-entry of the MSS from the serving BS; and
transmitting the detected network re-entry information to the MSS.

2. The method of claim 1, wherein the network re-entry information includes basic capability information, unique authorization information, and registration information of the MSS.

3. A method for performing network re-entry with a mobile subscriber station (MSS) by a target base station (BS) when the MSS is handed over to the target BS among a plurality of neighbor BSs, in a Broadband Wireless Access (BWA) communication system including the MSS, a serving BS providing a service to the MSS, and the plurality of neighbor BSs being different from the serving BS, the method comprising the steps of:
allocating an acknowledge (ACK) time slot, and transmitting an uplink map (UL-MAP) message including information on the allocated ACK time slot to the MSS;
after transmitting the UL-MAP message, generating a medium access control (MAC) message including a management message acknowledgement allocation subheader (MMAASH) and transmitting the MAC message to the MSS;
after transmitting the MAC message, determining whether a management message-acknowledge (MM-ACK) message is received from the MSS at an ACK time slot allocated to the MMAASH;
allocating an ACK time slot, and retransmitting a UL-MAP message including information on the allocated ACK time slot if it is determined that an MM-ACK message is not received from the MSS at an ACK time slot allocated to the MMAASH, and
re-generating a MAC message including an MMAASH, and retransmitting the re-generated MAC message.

4. The method of claim 3, further comprising the step of recognizing that the transmitted MAC message has been normally transmitted, if it is determined that an MM-ACK message is received from the MSS at an ACK time slot allocated to the MMAASH.

5. The method of claim 3, wherein the MMAASH includes information on an ACK time slot at which the MSS will transmit the MM-ACK message.

6. A method for performing network re-entry with a mobile subscriber station (MSS) by a target base station (BS) when the MSS is handed over to the target BS among a plurality of neighbor BSs, in a Broadband Wireless Access (BWA) communication system having the MSS, a serving BS providing a service to the MSS, and the plurality of neighbor BSs being different from the serving BS, and having a frame including a downlink subframe comprised of a plurality of downlink time slots and an uplink subframe comprised of a plurality of uplink time slots, the method comprising the steps of:
upon detecting handover of the MSS, detecting network re-entry information necessary for network re-entry of the MSS from the serving BS;
after detecting the network re-entry information, transmitting acknowledge (ACK) channel information based on which the target BS will respond that it has received the network re-entry information, if the MSS receives the network re-entry information; and
after transmitting the ACK channel information, transmitting, to the MSS, the detected network re-entry information, and ACK request information requesting the MSS to respond whether it has received the network re-entry information.

7. The method of claim 6, wherein the ACK request information includes information on an ACK time at which the MSS will respond whether it has received the network re-entry information.

8. The method of claim 7, wherein the ACK time information includes information on an uplink subframe and an uplink time slot, at which the MSS will respond whether it has received the network re-entry information.

9. The method of claim 7, further comprising the step of, after transmitting the network re-entry information and the ACK request information, retransmitting the network re-entry information and the ACK request information to the MSS upon failure to receive an ACK for the network re-entry information from the MSS at a time corresponding to the ACK time information.

10. The method of claim 6, wherein the network re-entry information includes basic capability information, unique authorization information, and registration information of the MSS.

11. A method for performing network re-entry with a target base station (BS) by a mobile subscriber station (MSS) when the MSS is handed over to the target BS among a plurality of neighbor BSs, in a Broadband Wireless Access (BWA) communication system including the MSS, a serving BS providing a service to the MSS, and the plurality of neighbor BSs being different from the serving BS, the method comprising the steps of:
upon receiving network re-entry information from the target BS during its handover to the target BS, receiving information on an acknowledge (ACK) channel through which the MSS will respond that it has received the network re-entry information;
after receiving the ACK channel information, receiving the network re-entry information from the target BS; and
after receiving the network re-entry information, responding to the target BS that it has received the network re-entry information, through the ACK channel.

12. The method of claim 11, wherein the network re-entry information includes basic capability information, unique authorization information, and registration information of the MSS.

13. A method for performing network re-entry with a target base station (BS) by a mobile subscriber station (MSS) when the MSS is handed over to the target BS among a plurality of neighbor BSs, in a Broadband Wireless Access (BWA) communication system including the MSS, a serving BS providing a service to the MSS, and the plurality of neighbor BSs being different from the serving BS, and having a frame including a downlink subframe comprised of a plurality of downlink time slots and an uplink subframe comprised of a plurality of uplink time slots, the method comprising the steps of:
upon receiving network re-entry information from the target BS during its handover to the target BS, receiving information on an acknowledge (ACK) channel through which the MSS will respond that it has received the network re-entry information;
after receiving the ACK channel information, receiving, from the target BS, the network re-entry information, and ACK request information requesting the MSS to respond that it has received the network re-entry information upon receipt of the network re-entry information; and
after receiving the network re-entry information and the ACK request information, responding to the target BS that the MSS has received the network re-entry information, through the ACK channel in response to the ACK request information.

14. The method of claim 13, wherein the ACK request information includes information on an ACK time at which the MSS will respond whether it has received the network re-entry information.

15. The method of claim 14, wherein the ACK time information includes information on an uplink subframe and an uplink time slot, at which the MSS will respond whether it has received the network re-entry information.

16. The method of claim 13, wherein the network re-entry information includes basic capability information, unique authorization information, and registration information of the MSS.

17. A method for performing network re-entry by a mobile subscriber station (MSS) when the MSS is handed over to a particular target base station (BS) among a plurality of neighbor BSs, in a Broadband Wireless Access (BWA) communication system having the MSS, a serving BS providing a service to the MSS, and the plurality of neighbor BSs being different from the serving BS, the method comprising the steps of:
upon its handover from the serving BS to the target BS, acquiring downlink (DL) and uplink (UL) synchronizations through an initial ranging operation with the target BS;
after acquiring the DL and UL synchronizations, receiving messages including information for network re-entry from the target BS; and
performing network re-entry to the target BS on a contention-free basis according to the messages received from the target BS.

18. The method of claim 17, wherein the messages including information for network re-entry from the target BS include a subscriber station's basic capability negotiation response (SBC-RSP) message including information on a modulation scheme and a coding scheme supportable by the MSS, a privacy key management response (PKM-RSP) message including authentication key information allocated to the MSS, and a registration response (REG-RSP) message including registration information of the MSS.

19. A method for performing network re-entry by a mobile subscriber station (MSS) when the MSS is handed over to a particular target base station (BS) among a plurality of neighbor BSs, in a Broadband Wireless Access (BWA) communication system having the MSS, a serving BS providing a service to the MSS, and the plurality of neighbor BSs being mutually exclusive to the serving BS, the method comprising the steps of:
receiving a downlink-map (DL-MAP) message and an uplink-map (UL-MAP) message from the target BS, and analyzing the received DL-MAP message and UL-MAP message;
receiving only a medium access control (MAC) message targeting the MSS as a result of the analysis, preprocessing the received MAC message, and detecting a MAC header from the preprocessed MAC message;
determining a value of the least significant bit (LSB) of the MAC header through the detection of the MAC header;
if the LSB has a value equivalent to 1, recognizing that a management message acknowledge (ACK) allocation subheader (MMAASH) is included in the MAC message, and detecting and analyzing the MMAASH; and
after detecting and analyzing the MMAASH, transmitting a management message-acknowledge (MM-ACK) message at an ACK time slot designated by the MMAASH.

20. The method of claim 19, further comprising the step of analyzing position information of the ACK time slot allocated to the MSS by analyzing the received DL-MAP message and UL-MAP message.

21. The method of claim 19, further comprising the step of, recognizing that the MMAASH is not included in the MAC message, and analyzing a payload for the received MAC message, if the LSB of the MAC header is not equivalent to 1.

22. A method for performing network re-entry between a mobile subscriber station (MSS) and a particular target base station (BS) among a plurality of neighbor BSs within the shortest time when the MSS is handed over to the target BS, in a Broadband Wireless Access (BWA) communication system having the MSS, a serving BS providing a service to the MSS, and the plurality of neighbor BSs being different from the serving BS, the method comprising the steps of:
upon its handover from the serving BS to the target BS, acquiring, by the MSS, downlink and uplink synchronizations through an initial ranging operation with the target BS; and
upon handover of the MSS, transmitting, regardless of reception of a request message from the MSS, by the target BS, messages including information for network re-entry to the MSS.

23. The method of claim 22, wherein the messages transmitted to the MSS include a subscriber station's basic capability negotiation response (SBC-RSP) message including information on a modulation scheme and a coding scheme supportable by the MSS, a privacy key management response (PKM-RSP) message including authentication key information allocated to the MSS, and a registration response (REG-RSP) message including registration information of the MSS.

24. The method of claim 22, further comprising the step of receiving, by the target BS, messages including information based on which the MSS will perform network re-entry, from the serving BS prior to handover to the target BS.

25. The method of claim 22, wherein the messages including information based on which the MSS will perform network re-entry include a subscriber station's basic capability negotiation response (SBC-RSP) message including information on a modulation scheme and a coding scheme supportable by the MSS, a privacy key management response (PKM-RSP) message including authentication key information allocated to the MSS, and a registration response (REG-RSP) message including registration information of the MSS.

26. A system for performing network re-entry when a mobile subscriber station (MSS) is handed over to a particular target base station (BS) among a plurality of neighbor BSs, in a Broadband Wireless Access (BWA) communication system having the MSS, a serving BS providing a service to the MSS, and the plurality of neighbor BSs being different from the serving BS, the system comprising:
the target BS for, upon detecting handover of the MSS, detecting network re-entry information necessary for network re-entry of the MSS from the serving BS, and transmitting the detected network re-entry information to the MSS; and
the MSS for receiving the network re-entry information.

27. The system of claim 26, wherein the network re-entry information includes basic capability information, unique authorization information, and registration information of the MSS.

28. A system for performing network re-entry when a mobile subscriber station (MSS) is handed over to a particular target base station (BS) among a plurality of neighbor BSs, in a Broadband Wireless Access (BWA) communication system having the MSS, a serving BS providing a service to the MSS, and the plurality of neighbor BSs being different from the serving BS, the system comprising:
the target BS for, upon detecting handover of the MSS, detecting network re-entry information necessary for network re-entry of the MSS from the serving BS, and transmitting, to the MSS, the detected network re-entry information, and information on an acknowledge (ACK) channel through which the MSS will respond that it has received the network re-entry information upon receipt of the network re-entry information; and
the MSS for receiving the ACK channel information, thereafter, receiving the network re-entry information from the target BS, and responding to the target BS that the MSS has received the network re-entry information, through the ACK channel.

29. The system of claim 28, wherein the network re-entry information includes basic capability information, unique authorization information, and registration information of the MSS.

30. A system for performing network re-entry when a mobile subscriber station (MSS) is handed over to a particular target base station (BS) among a plurality of neighbor BSs, in a Broadband Wireless Access (BWA) communication system having the MSS, a serving BS providing a service to the MSS, and the plurality of neighbor BSs being different from the serving BS, and having a frame including a downlink subframe comprised of a plurality of downlink time slots and an uplink subframe comprised of a plurality of uplink time slots, the system comprising:
the target BS for, upon detecting handover of the MSS, detecting network re-entry information necessary for network re-entry of the MSS from the serving BS, and transmitting, to the MSS, the detected network re-entry information, information on an acknowledge (ACK) channel through which the MSS will respond that it has received the network re-entry information upon receipt of the network re-entry information, and ACK request information requesting the MSS to respond whether the MSS has received the network re-entry information; and
the MSS for receiving the ACK channel information, thereafter receiving, from the target BS, the network re-entry information and the ACK request information, and responding to the target BS that it has received the network re-entry information, through the ACK channel in response to the ACK request information.

31. The system of claim 30, wherein the ACK request information includes information on an ACK time at which the MSS will respond whether it has received the network re-entry information.

32. The system of claim 31, wherein the ACK time information includes information on an uplink subframe and an uplink time slot, at which the MSS will respond whether it has received the network re-entry information.

33. The system of claim 31, wherein the target BS, after transmitting the network re-entry information and the ACK request information, retransmits the network re-entry information and the ACK request information to the MSS upon failure to receive an ACK for the network re-entry information from the MSS at a time corresponding to the ACK time information.

34. The system of claim 30, wherein the network re-entry information includes basic capability information, unique authorization information, and registration information of the MSS.
